(19) United States
(12) Patent Application Publication
(10) Pub. No.: US 2023/0210140 A1
(43) Pub. Date: Jul. 6, 2023

(54) FLOATING CRYSTALLINE TASTANT PARTICLES

(71) Applicant: SOCIETE DES PRODUITS NESTLE S.A., Vevey (CH)

(72) Inventors: ANNABEL BOZON, Boca Raton, FL (US); LENNART FRIES, Belmont-sur-Lausanne (CH); BENJAMIN LE REVEREND, Kirkwood, MO (US); AGBA SALMAN, Sheffield (GB)

(21) Appl. No.: 17/597,053

(22) PCT Filed: Jun. 25, 2020
(86) PCT No.: PCT/EP2020/067940

§ 371 Date: Jul. 27, 2022

(30) Foreign Application Priority Data
Jun. 26, 2019 (EP) 19182666.8

(51) Int. Cl. A23L 2/395; A23L 2/60; A23P 10/35

(52) U.S. Cl. CPC A23L 2/395; A23L 2/60; A23P 10/35

(57) ABSTRACT

A beverage powder comprising crystalline tastant particles characterized in that the crystalline tastant particles are at least partially coated with a hydrophobic coating, and wherein the at least partially coated crystalline tastant particles have an average density greater than 1 g/cm³, preferably greater than 1.5 g/cm³. A method of coating crystalline tastant particles for use in a powdered food product, preferably a beverage powder, is also provided.

### BACKGROUND

Reconstituted powders offer a convenient solution for the preparation of beverages such as coffee mixes. However, these products frequently contain high quantities of tastants like sugar. Due to the growing consumer demand for healthier food products, the quantity of certain tastants needs to be reduced. However, a reduced tastant concentration also results in undesired changes of sensory properties. Previous research has shown that it is possible to reduce the total quantity of tastants (such as sugar, sweetener, salt and fat) without deterioration of taste perception/intensity, if a particular stimuli distribution is assured.

In order to apply this concept for powdered beverages, a tastant concentration gradient with high tastant concentration (e.g. sugar) in the top of the cup has to be achieved upon reconstitution. This will lead to increased perception of sweetness in comparison to evenly distributed sucrose.

Amorphous porous particles have previously been used to deliver tastants on the top of a beverage (W02018/224542 A1). The high closed porosity (10-80%) leads to floating of particles on the water surface. The particles dissolve in the top region and create a concentration gradient in the beverage. This solution requires specific processing to generate sugar in its amorphous state. This amorphous material has an increased sensitivity towards moisture and temperature in comparison to its crystalline counterpart. This is not applicable for crystalline materials.

Multi-layer beverages can be produced by layering liquid of varying densities (U.S. Pat. No. 7,013,933B2). The density of liquid layers decreases from the form the bottom to the top of the cup. This principle is applied for example in Cappuccino-type beverages.

W02016/071744 A1 describes a tablet (containing creamer/whitening component, flavouring and a biscuit component) used for the formation of a layered beverage. A foaming ingredients builds up a foam on the beverage surface whereas the dense biscuit component forms the lowest layer. The layers are therefore formed as a result of their relative densities.

W02016/020367 A1 describes a multilayer tablet for the formation of a multi-layer beverage. The tablet consists of a dark component containing (sugar, coffee and/or cocoa particles, density range: 0.5-0.7 g/cm³) and a white component (containing creamer and sugar, density range: 0.74-0.9 g/cm³).

None of these approaches address the problem that certain tastants, for example sucrose in its crystalline form, immediately sink upon contact with water.

### SUMMARY OF THE INVENTION

It has surprisingly been found that the partial or full coating of crystalline sucrose particles with small quantities of a solid fat leads to the formation of a concentration gradient. This ultimately results in an increased taste perception and can be used to decrease the overall sucrose concentration in powdered food products that are reconstituted e.g. by the consumer.

Suitable hydrophobic coating materials include for example cocoa butter, palm fat, butter fat, and coconut fat. The applied coating leads to particle floating, even if the overall density of the coated particle remains well above the water density of 1 g/cm³, such as 1.59 g/cm³ for sucrose coated with 0.1% cocoa butter.

The coated sucrose particles can be used as ingredients in various powdered food products.

Surprisingly, it was found that even minor quantities of solid fat (e.g. 0.1-0.6% cocoa butter) are sufficient to achieve particle floating. Moreover, particles do not have to be covered with a complete coating. A partial coating and thus a heterogeneous distribution of solid fat (patches or spots of fat) is adequate to achieve floating behaviour. Hence, the particle surface only has to be partially hydrophobic.

The reduction of wettability and corresponding increase of acting capillary forces were identified as factors of main relevance. Immediate sinking due to high solid density is circumvented by the reduction of wettability. Minor quantities of solid fat had a great and significant impact on wettability, as indicated by contact angle measurements. An effect of altered solid density can be excluded as the applied lipid quantities are not large enough to decrease the particle density below the density of water.

The described solution can be applied for standard crystalline sugar or salt and only requires (heterogeneous or homogeneous) distribution of a hydrophobic material (e.g. solid fat) on the particle surface. The use of crystalline tastants e.g. crystalline sucrose are in general accompanied by a high shelf-life and low sensitivity towards moisture and temperature. Hence, product stability and handling is improved compared to amorphous materials.

### BRIEF DESCRIPTION OF FIGURES

FIG. 1: Microscopic images (50× magnification) of pure (SpR) and coated (SpC1-SpC3) spherical sucrose particles. Scale bar of 100 μm is shown in bottom right hand corner of each image.

FIG. 2: Scanning electron micrographs of SpR particles recorded at 10 kV. a) 40× magnification; b) 100× magnification

FIG. 3: Scanning electron micrographs of SpC1 (0.1% cocoa butter) recorded at 10 kV. a) 40× magnification; b) 100× magnification; c) 100× magnification with indication of cocoa butter; d) close-up image c with indication of cocoa butter

FIG. 4: Scanning electron micrographs of SpC2 recorded at 10 kV. a) 40× magnification; b) 100× magnification; c) 100× magnification with indication of cocoa butter; d) close-up image c with indication of cocoa butter

FIG. 5: Scanning electron micrographs of SpC3 recorded at 10 kV. a) 40× magnification; b) 100× magnification example 1; c) 100× magnification example 2; d) close-up image c; e) 100× magnification example 3; f) close-up image e

FIG. 6: Dropping of pure sucrose particles on the water surface (left), sucrose layer formed on the container bottom (right)

FIG. 7: Small-scale wetting test of coated sucrose samples S1-S3

FIG. 8: Images obtained during floating of single coated particles 1 s after dropping and corresponding percentage of particle immersion (average of 10 replicates)

FIG. 9: Microscopic images of pure sucrose (left) and sucrose coated with 1.2% cocoa butter (right). Scale bar of 1000 μm is shown in bottom right hand corner of each image.

FIG. 10: Standard wetting test of pure sucrose (right) and 1.2% cocoa butter coated sucrose (middle) as well as “inverse” wetting test of 1.2% cocoa butter coated sucrose, performed at room temperature

FIG. 11: Standard wetting test of 1.2% cocoa butter coated sucrose at 40° C. (left) and 65° C. (right) water temperature

FIG. 12: Microscopic images of sample SP1-SP4, coated with palm fat using high-shear mixing. Scale bar of 1000 μm is shown in bottom right hand corner of each image.

FIG. 13: Standard wetting test of sucrose coated with different quantities of palm fat using high-shear mixing

FIG. 14: Standard wetting test of sucrose coated with different quantities of palm fat using high-shear mixing, conducted at 40° C. and 65° C.

FIG. 15: Standard wetting test of sucrose coated with 0.8 and 1.3% palm fat using high-shear mixing, conducted at 40° C.

FIG. 16: Microscopic images of sample SSo1-SSo3, coated with sunflower oil using high-shear mixing. Scale bar of 1000 μm is shown in bottom right hand corner of each image.

FIG. 17: Standard wetting test of sucrose coated with different quantities of sunflower oil using high-shear mixing

FIG. 18: Standard wetting test of sucrose coated with palm fat or cocoa butter

### EMBODIMENTS OF THE INVENTION

The present invention relates in general to a powdered food product comprising crystalline tastant particles, characterized in that the tastant particles are at least partially coated with a hydrophobic coating.

In particular, the invention relates to a beverage powder comprising crystalline tastant particles characterized in that the crystalline tastant particles are at least partially coated with a hydrophobic coating, and wherein the at least partially coated crystalline tastant particles have an average density greater than 1 g/cm³, or greater than 1.25 g/cm³, or greater than 1.5 g/cm³.

In some embodiments, the coated tastant particles have an average density of between 1.2 g/cm³ and 2 g/cm³, or between 1.3 g/cm³ and 1.9 g/cm³, or between 1.4 g/cm³ and 1.8 g/cm³, or between 1.5 g/cm³ and 1.7 g/cm³, or between 1.55 g/cm³ and 1.6 g/cm³

In some embodiments, the tastant particles are sucrose particles.

In some embodiments, the tastant particles have an average size of between 200-1000 μm, or between 300-900 μm, or between 400-800 μm, or between 500-710 μm.

In some embodiments, the tastant particles are sucrose particles with an average size of between 500-710 μm.

In some embodiments, the surface area of the tastant particles are, on average, at least 1% coated, or at least 5% coated, or at least 10% coated, or at least 15% coated, or at least 20% coated, or at least 40% coated, or at least 50% coated, or at least 60% coated, or at least 70% coated, or at least 80% coated, or at least 90% coated with a hydrophobic coating.

In some embodiments, the surface area of the tastant particles are, on average, between 1% to 50% coated, or between 1% to 20% coated, or between 10% to 20% coated with a hydrophobic coating.

In some embodiments, the tastant particles have a heterogeneous surface chemistry.

In some embodiments, the surface area of the tastant particles comprise, on average, at least 5, or 10, or 20, or 30, or 40, or 50 discrete areas of hydrophobic coating.

In some embodiments, the surface area of the tastant particles are, on average between 1% to 50% coated with a hydrophobic coating and comprise, on average, at least 5 areas of hydrophobic coating.

In some embodiments, the surface area of the tastant particles are entirely coated with a hydrophobic coating.

In some embodiments, the coated tastant particles comprise, on average, at least 98.6 wt % sucrose, or at least 98.8 wt % sucrose, or at least 99 wt % sucrose, or at least 99.2 wt % sucrose, or at least 99.4 wt % sucrose, or at least 99.6 wt % sucrose, or at least 99.8 wt % sucrose.

In some embodiments, the hydrophobic coating is solid fat or wax.

In some embodiments, the coated tastant particles comprise, on average, at least 0.025 wt % solid fat or wax, or at least 0.05 wt % solid fat or wax, or at least 0.075 wt % at least 0.1 wt % solid fat or wax, or at least 0.3 wt % solid fat or wax, or at least 0.6 wt % solid fat or wax, or at least 0.8 wt % solid fat or wax, or at least 1 wt % solid fat or wax, or at least 1.2 wt % solid fat or wax.

In some embodiments, the hydrophobic coating is a solid fat and has a melting point of greater than about 35° C., between about 35 to 60° C., or between about 35 to 37° C., or between about 44 to 46° C., or between about 58 to 60° C.

In some embodiments, the hydrophobic coating is a wax and has a melting point of between about 62 to 88° C., or about 62 to 65° C., or about 82 to 88° C.

In some embodiments, the solid fat is selected from cocoa butter, palm fat, butter fat or coconut fat. In some embodiments, the solid fat is cocoa butter. In some embodiments, the solid fat is palm fat.

In some embodiments, the coated tastant particles comprise, on average, between about 0.1 to 1.8% cocoa butter, or about 0.1% cocoa butter, or about 0.3% cocoa butter, or about 0.6% cocoa butter, or about 0.9% cocoa butter, or about 1.2% cocoa butter, or about 1.5% cocoa butter, or about 1.8% cocoa butter.

In some embodiments, the coated tastant particles comprise, on average, between about 0.05 to 0.6% palm fat, or between about 0.1 to 0.5% palm fat, or between about 0.2 to 0.4% palm fat, or about 0.3% palm fat.

In some embodiments, the wax is selected from carnauba wax or beeswax.

In some embodiments, the coated tastant particles have a contact angle with water of, on average, greater than 700, or greater than 80°, or greater than 90°.

In some embodiments, the coated tastant particles have a contact angle with water of, on average, about 100°.

In some embodiments, the coated tastant particles have a contact angle with water of, on average, less than 150°, or less than 140°, or less than 130°, or less than 120°, or less than 110°.

In some embodiments, the coated tastant particles have a contact angle with water of, on average, between 70° and 150°, or between 80° and 140°, or between 90° and 130°.

In some embodiments, the beverage powder is suitable for reconstitution in a liquid at a temperature of less than about 82° C., or at a temperature of less than about 62° C., or at a temperature of less than about 58° C., or at a temperature of less than about 44° C., or at a temperature of less than about 35° C., or at a temperature of less than about 30° C., or at a temperature of about 23° C.

In some embodiments, the beverage powder is suitable for reconstitution in water, milk, coffee, or chocolate milk.

The invention also relates to a method for coating crystalline tastant particles with a hydrophobic coating, preferably solid fat or wax.

In some embodiments, the method comprises the steps:
a. Fluidization of crystalline tastant particles;
b. Application of a hydrophobic coating, preferably molten or tempered cocoa butter onto the tastant particles, preferably by spraying;
c. Fluidization to allow solidification of the hydrophobic coating, preferably at between 20-25° C.

In some embodiments, the spraying time is at least 4 minutes, or at least 6 minutes or at least 9 minutes, or for about 10 minutes.

In some embodiments, the method comprises the steps:
a. Mixing crystalline tastant particles with oil or molten fat or tempered fat, preferably using a shear mixer, preferably at about 300 rpm;
b. Spreading out the mixture as a powder layer;
c. Storing, preferably at about 70° C., preferably for about 20 to 25 minutes;
d. Mixing, preferably for 5 minutes, preferably at about 300 rpm;
e. Spreading out the mixture as a layer and allowing it to solidify.

In some embodiments, the fat is cocoa butter, preferably at a final amount of 0.1 to 1.2 wt %, preferably about 1.2 wt %.

In some embodiments, the fat is palm fat, preferably at a final amount of 0.2 to 0.3 wt %, preferably about 0.3 wt %.

The invention also relates to coated crystalline tastant particles, obtained by a method as described herein.

The invention also relates to the use of coated crystalline tastant particles in a powdered food product, preferably a beverage powder.

### DETAILED DESCRIPTION OF THE INVENTION

As used herein the term “about” means approximately, in the region of, roughly, or around. When the term “about” is used in conjunction with a numerical value or range, it modifies that value or range by extending the boundaries above and below the numerical value(s) set forth. In general, the terms “about” is used herein to modify a numerical value(s) above and below the stated value(s) by 1%, or 5%, or 10%, or 20%.

As used herein, powdered food product can be a beverage powder (for example, coffee, coffee mixes, milk powder, chocolate powder, infant formula, malt beverage powder), a soup powder, or a sauce powder.

As used herein, “crystalline particles” or “crystalline tastant particles” are characterised by having a three-dimensional long-range order of atomic positions. The atoms of crystals are arranged in a translationally periodic array. In contrast, amorphous particles possess a non-periodic array with highly-disordered atomic position.

Crystalline solids are characterised by having one melting point, at which the transition between solid and liquid state occurs (compared to T_{g} for amorphous solids). They dissolve once a critical relative humidity is reached, e.g. 83-85% for sucrose. Below this value, only negligible quantities of water can be found in crystals (stored as crystal water in the crystalline matrix).

As used herein, the term “tastant” refers to a material that stimulates the sense of taste. Tastants are used in food and beverages to achieve a desired taste profile. Examples of crystalline tastant particles include sugar and salt.

The sensation of taste includes five established basic tastes: sweetness, sourness, saltiness, bitterness and umami. The term taste as used herein is distinct from aroma (detected by the nose) and flavour, of which taste and aroma are components. The particles comprising a tastant may further comprise an aroma. The tastant according to the invention may provide a taste selected from the group consisting of sweet, salty and umami, for example the tastant may be sweet or salty.

The tastant particle of the invention is preferably sweet, for example sucrose, lactose, maltose, glucose, fructose, isomaltulose, galactose, and allulose. In one embodiment, the tastant particle is sucrose. In one embodiment, the tastant particle is a polyol. In one embodiment, the tastant particle is a rare sugar. The tastant particle of the invention may be salty. In one embodiment, the tastant particle is sodium chloride.

As used herein, the term “hydrophobic coating” refers to a structure in which a core material (here the tastant) is either fully or partially covered with a hydrophobic coating material (shell/capsule/wall material), which results in a reduced wettability or reduced wetting behaviour.

The term wettability describes the affinity (molecular interactions) between the solid and liquid, preferably water, and is commonly assessed via the solid-liquid contact angle. The contact angle reflects the degree of wetting when the liquid is coming into contact with the solid.

The applied hydrophobic coating materials are characterised by having a low wettability with water. The affinity between hydrophobic materials and water is low. Water tends to reduce the contact area to the solid. The corresponding contact angle is high. Hydrophobic materials are commonly characterised by a contact angle with water above 90°.

Different hydrophobic materials can be used as coating agents. In some embodiments, these include solid fats such as palm fat, cocoa butter, milk fat. In some embodiments, these include waxes such as beeswax, carnauba wax. In some embodiments, these include fatty acids. The hydrophobicity is influenced by the structural properties of hydrocarbon chain. The longer the hydrocarbon chain and the lower the degree of unsaturation, the more hydrophobic and the lower the water solubility.

Examples of Suitable Coating Materials:

| Solid fat or wax | Melting point |
|---|---|
| Cocoa butter | 35-37° C. |
| Palm fat (high-melting) | 58-60° C. |
| Palm fat (low-melting) | 44-46° C. |
| Carnauba wax | 82-88° C. |
| Beeswax | 62-65° C. |

The coating process can be conducted with different techniques. In some embodiments, these include fluidized bed coating, high-shear mixing, drum coating, spray chilling/cooling.

The term “solid fat” as used herein refers to a lipid which is solid at room temperature. Lipids are commonly defined as materials which are insoluble in water but soluble in nonpolar solvents and include, inter alia, fats and oil, waxes and phospholipids.

Solid fats are characterised by a solid fat content which leads to melting temperatures above ambient temperature. In contrast, oils are liquid at room temperature. Solid fats include for example, palm fat, cocoa butter, milk fat, coconut fat and rhea butter.

Fats are usually comprised of a mixtures of lipids, mainly (triacylglycerols (generally over 95%), di- and monoacylglycerols, free fatty acids. Further components such as phospholipids, tocopherols and fat-soluble vitamins are typically present. Fats and oils are hydrophobic and therefore basically insoluble in water. Solid Fat Content can be measured according to method ISO 8292-1:2008.

As used herein, the term “sphericity” is defined as the ratio of the surface of the sphere with the equivalent volume to the actual surface of the particle. For ideal spherical particles the value of the ratio approximates 1.

### EXAMPLES

### Example 1

Coating Process Methodology

Coating of particles can be performed with different methods. Two different methods are described below which are suitable to provide floating particles.

Fluidized Bed Coating:

Crystalline sucrose particles were coated with varying quantities of cocoa butter using fluidized-bed technology. Sucrose particles were fluidized in the process chamber and molten cocoa butter (approx. 70° C.) was sprayed on top. Subsequently to spraying, powder was continuously fluidized for 10 min (20-25° C. fluidizing air temp.) to allow solidification of cocoa butter. This method can be used to provide a precise quantity of coating.

High-Shear Mixing:

Crystalline sucrose particles were coated with varying quantities of fat/oil using a bench-top Food processor (Kenwood) comprising a custom made high-shear mixer impeller (University of Sheffield). Impeller speed was controlled with a 240 V, 7 Amps regulator (University of Sheffield). Sucrose particles were mixed at approx. 300 rpm in the mixing vessel and oil (RT) or molten fat (70° C.) was slowly poured on top. After addition of liquid oil/fat, powder was continuously mixed for 5 min at approx. 300 rpm. Subsequently, the sample was removed from mixing vessel, spread out as powder layer and stored at 70° C. for 20-25 min. This procedure was chosen to melt solid fat to reduce the amount of lumps in the mix. A second mixing step was then performed for 5 min at 300 rpm. Afterwards, the sample was spread out as thin layer and solidified overnight at ambient temperature.

### Example 2

Fluidized Bed Coating of Spherical Sucrose with Cocoa Butter

Spherical sucrose particles (Nonpareil 103) were coated with small quantities of cocoa butter using fluidized bed technology. Composition and density of samples (SpC1-SpC3) is given in Table 1. Fat content was determined via fat extraction. Pure crystalline sucrose spheres (SpR) were used as a reference material. Since the applied cocoa butter quantities were small, particle density does not vary to a great extent.

TABLE 1
Composition and density of coated samples

| | Cocoa butter content | Sucrose content | Density |
|---|---|---|---|
| Samples | [%] | [%] | [g/cm³] |
| SpR | 0 | 100 | 1.5871 |
| SpC1 | 0.1 | 99.9 | 1.5861 |
| SpC2 | 0.3 | 99.7 | 1.5841 |
| SpC3 | 0.6 | 99.4 | 1.5811 |

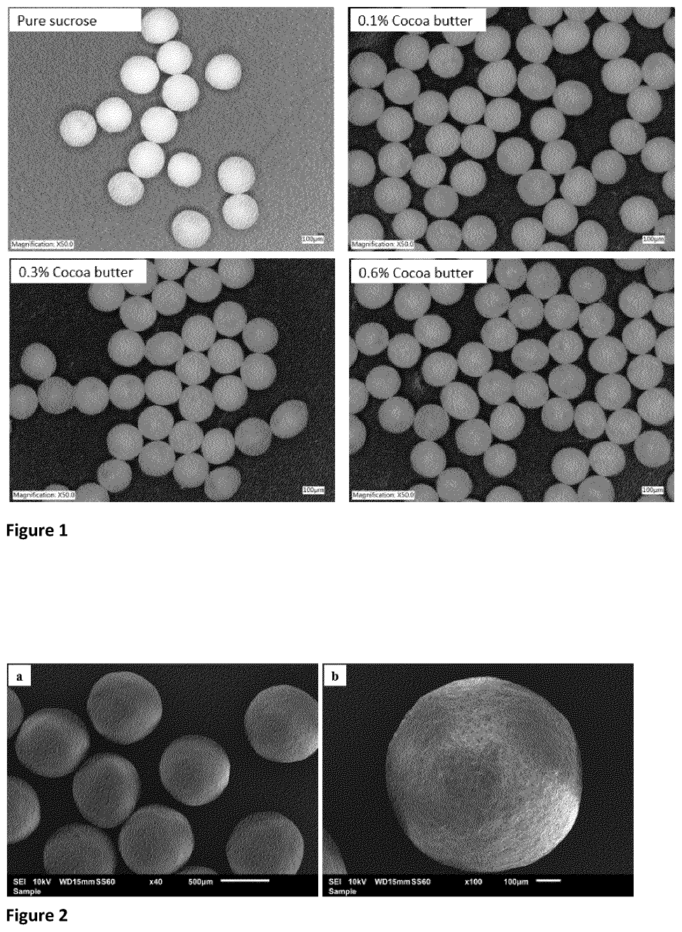

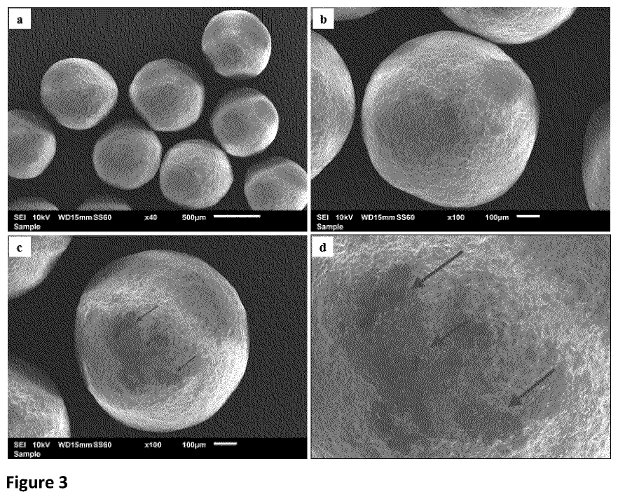

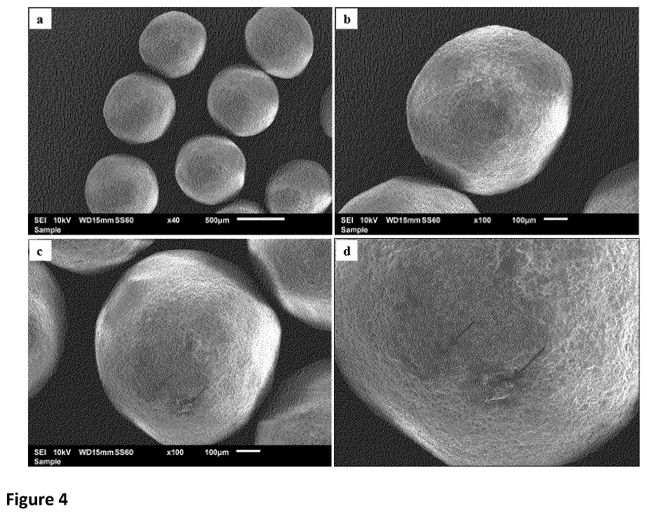

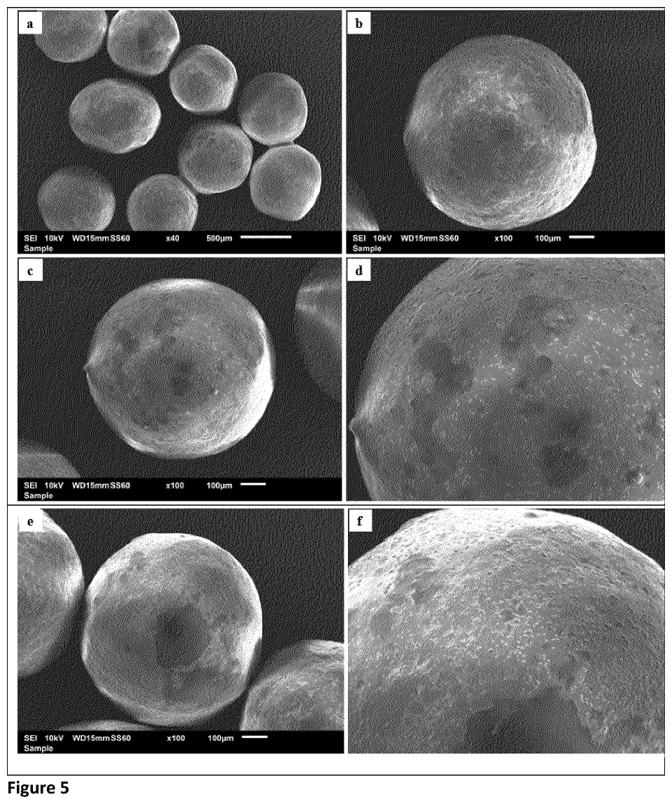

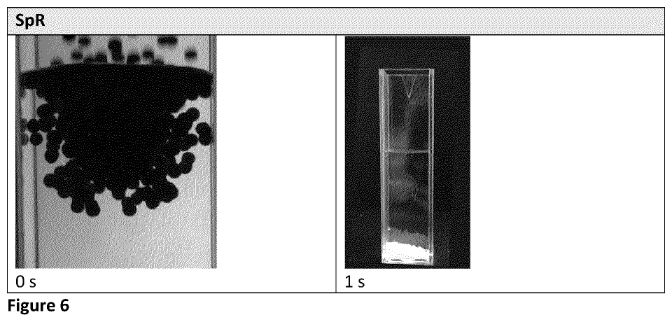

No visible difference in the appearance of reference and coated samples can be observed, as shown by microscopic images (FIG. 1). SEM images of pure and coated particles are shown in FIGS. 2 to 5. Surface coverage with cocoa butter is not clearly visible for sample SpC1 and SpC2. Merely patches of cocoa butter can be observed on the surface of some particles. A different observation was made for particles of samples SpC3. For the majority of particles, almost the complete particle surface seems to be covered with cocoa butter.

### Example 3

Effect of Cocoa Butter Coating on Wettability

Apparent contact angles were measured using sessile drop technique. A layer of coated powder was fixed to an adhesive tape and a liquid droplet was placed on the powder layer. For pure sucrose a tablet was pressed (pressure: 20 kN, compaction speed: 10 mm/min) and the liquid droplet was positioned on the tablet. Contact angles were measured using a goniometer.

Measured apparent contact angles are given in Table 2. Particle coating led to significantly increased apparent contact angles. Apparent contact angles increased with increasing cocoa butter content.

TABLE 2
Apparent contact angles of pure and
coated spherical sucrose particles

| Sample | Apparent contact angle [°] |
|---|---|
| Pure sucrose | 20 ± 5 |
| SpC1 | 75 ± 5 |
| SpC2 | 85 ± 5 |
| SpC3 | 110 ± 4 |

### Example 4

Effect of Cocoa Butter Coating on Powder and Particle Floating Floating behavior was investigated using microscopy. A polystyrene cuvette, filled with 3.5 ml distilled water (23±1° C.) was placed in front of a tilted microscope lens and 0.19 g sample was dropped on the water surface. The same set-up was used to study floating of each sample on single particle level.

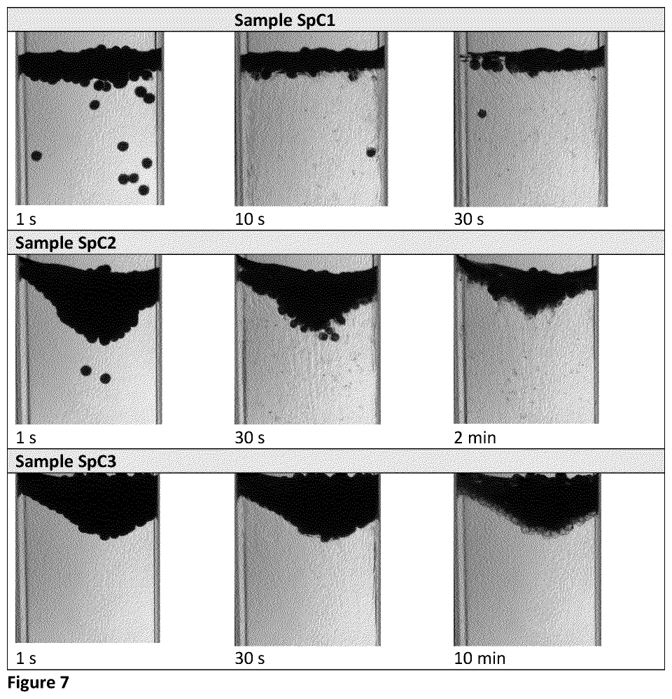

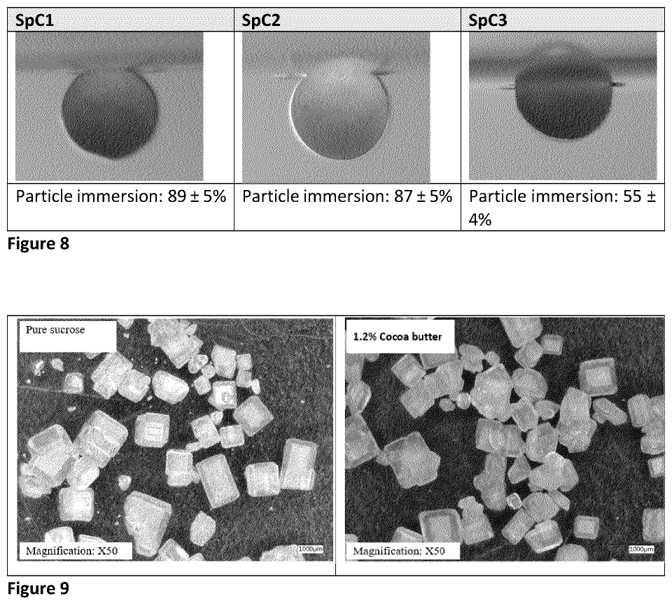

Pure sucrose directly sank upon dropping on the water surface (FIG. 6). Floating behavior of sample SpC1-SpC3 at different time points after dropping is shown in FIG. 7. All coated samples showed floating behavior. It has been found that quantity of floating powder and floating/dissolution time depend on the coating quantity. The analysis of single particle floating revealed, that increased coating quantities reduce particle immersion depths (FIG. 8).

### Example 5

Fluidized Bed Coating of Standard Sucrose with Cocoa Butter

Standard crystalline sucrose (Schweizer Zucker AG) was coated with 1.2±0.1% cocoa butter (determined via fat extraction) using fluidized bed technology. Pure crystalline sucrose was used as a reference material. Microscopic images of samples are shown at 50× magnification in FIG. 9. Coating does not result in any obvious changes of sucrose appearance.

### Example 6

Effect of Cocoa Butter Coating on Powder Floating

Powder floating/sinking was assessed using a standard wetting test. For the test, 15 g sample was added in a steel funnel (diameter 3 cm). This funnel was positioned on a glass plate on top of a beaker (diameter 7 cm). The glass beaker contained 200 ml of water (RT). The glass plate was withdrawn by hand and wetting and sinking behaviour of powder was observed. Additionally, mixing of the dispersed powder was performed manually after 10 min and floating behaviour after mixing was assessed.

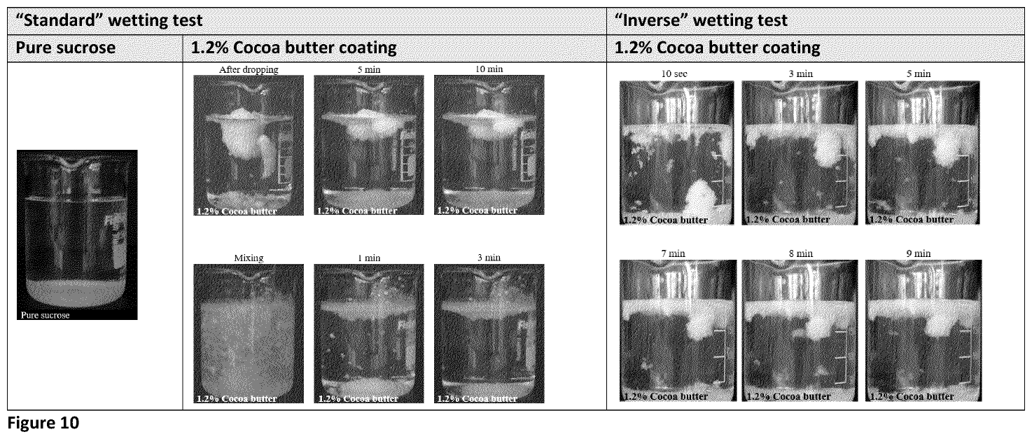

Pure sucrose immediately sinks upon contact with water and forms a layer of sucrose on the beaker bottom (FIG. 10, left). Coated sucrose behaved considerably different. Most powder did float on the liquid surface. Furthermore, continuous rising of remaining powder to the surface was observed. After 10 min., only a small amount of powder is located on the beaker bottom. Even after mixing, rise of powder to the surface of the beaker could be observed (FIG. 10, middle).

An “inverse wetting test” was conducted, to further evaluate floating behaviour of coated powder. The powder (15 g) was added to the beaker (diameter: 7 cm) first. Subsequently, 200 ml water (RT) were poured on top. Floating and movement of powder was observed for 10 min.

As observed previously, pure sucrose forms a layer on the beaker bottom. In contrast to this, a part of the coated powder is directly floating on the surface upon water addition. Continuous rising of powder from the beaker bottom to the surface was observed (FIG. 10, right).

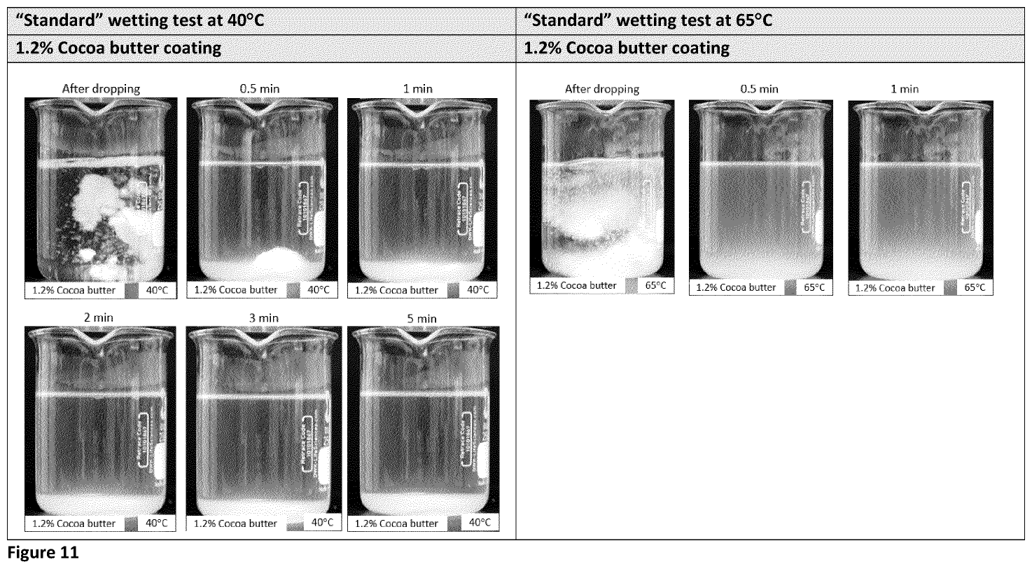

The standard wetting test was additionally conducted at water temperatures of 40° C. and 65° C. (FIG. 11). Higher water temperatures led to immediate sinking of sucrose, which can be explained by melting of cocoa butter (melting point: 35-37° C.).

### Example 7

Coating of Standard Sucrose with Palm Fat Using High-Shear Mixing

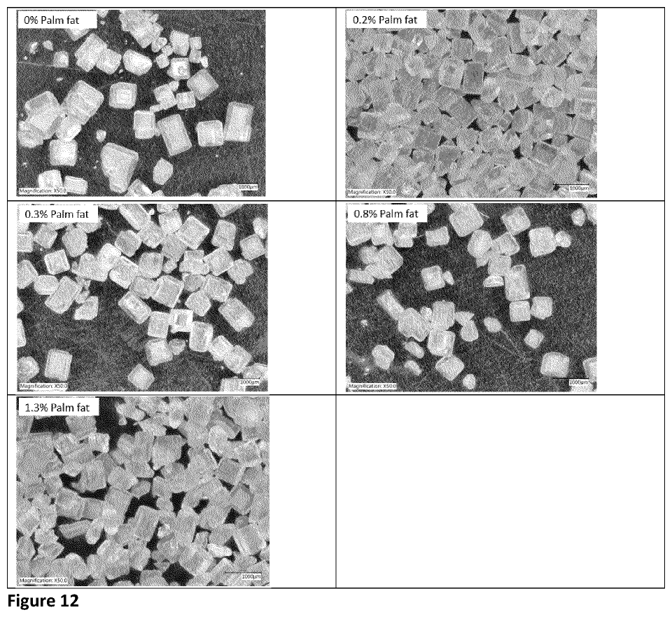

Standard sucrose (Schweizer Zucker AG, size class 500-710 μm) was coated with small quantities of palm fat (CLSP, 555, fully hydrogenated palm kernel oil, Solid fat at 20° C.: 93-97%) using high-shear mixing. Composition of produced samples is given in Table 3. The fat content was determined by solvent extraction with n-Heptane at room temperature. Pure crystalline sucrose was used as a reference material. No difference in the appearance of each sample can be observed, as shown by microscopic images (FIG. 12).

TABLE 3
Composition of sample SP1-SP4 coated
with palm fat using high-shear mixing

| Sample | Palm fat [%] | Sucrose [%] |
|---|---|---|
| SP1 | 0.2 ± 0 | 99.8 |
| SP2 | 0.3 ± 0 | 99.7 |
| SP3 | 0.8 ± 0 | 99.2 |
| SP4 | 1.3 ± 0 | 98.7 |
| Reference | 0 | 100 |

### Example 8

Effect of Palm Fat Coating on Powder Floating

Powder floating/sinking was assessed using a standard wetting test. For the test, 15 g sample was added in a steel funnel (diameter 3 cm). This funnel was positioned on a metal plate on top of a beaker (diameter 7 cm, powder dropping height: 4.5 cm). The glass beaker contained 200 ml of water (23±1° C.). The plate was withdrawn by hand and floating/sinking behaviour of powder recorded. Additionally, mixing of the dispersed powder was performed manually after 10 min and floating behaviour after mixing was assessed.

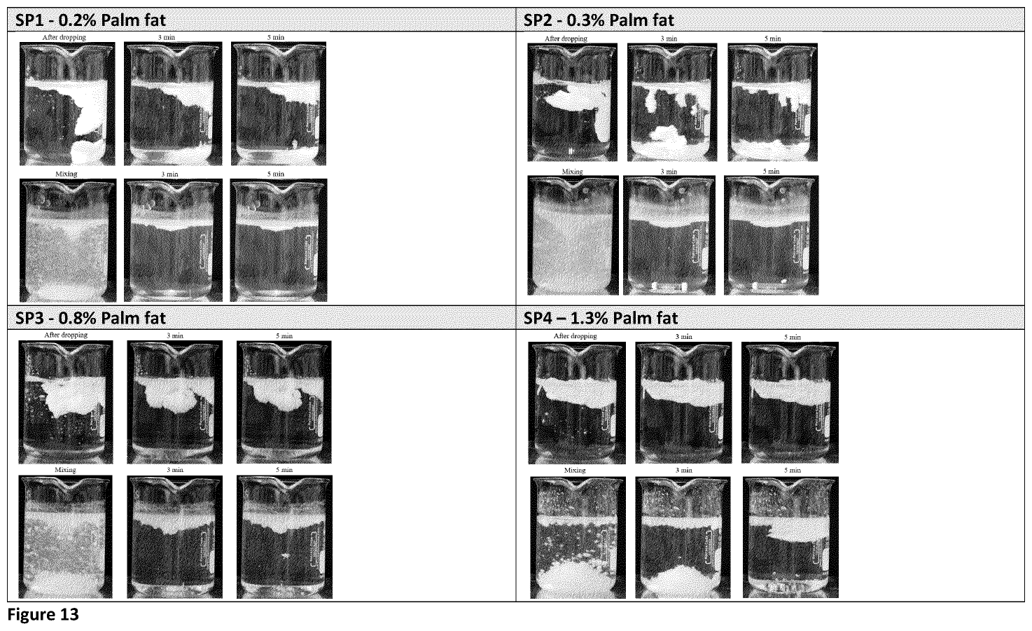

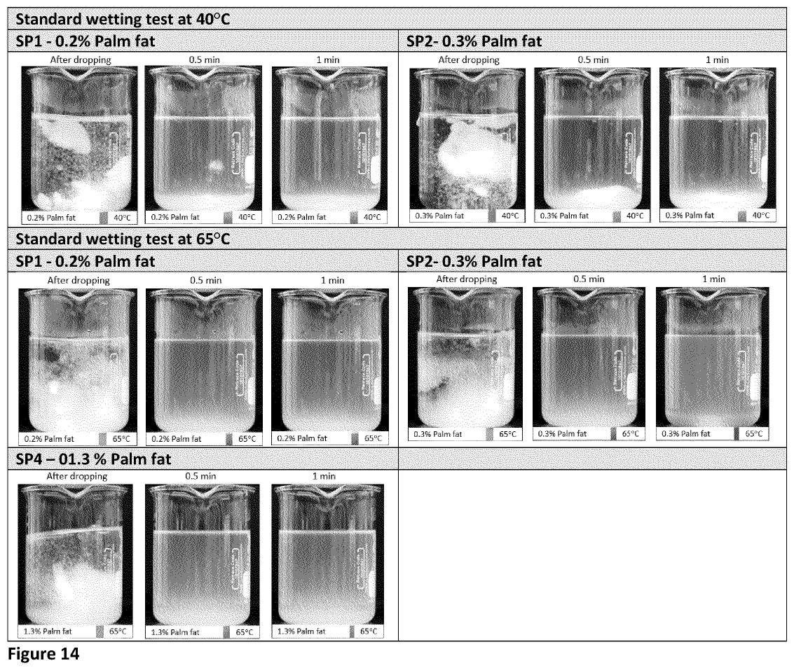

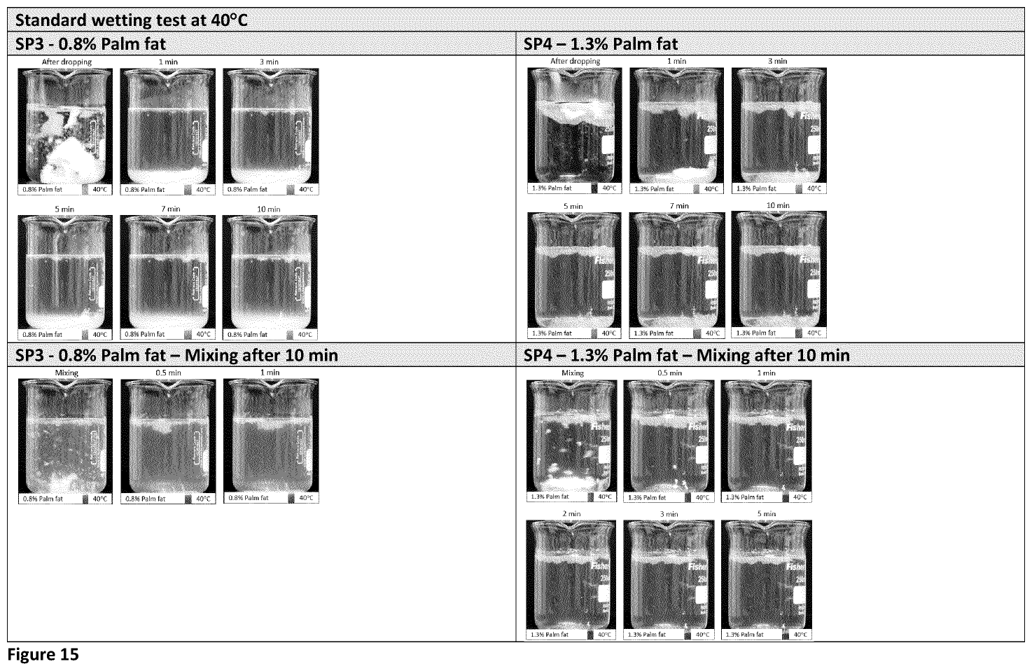

Floating behaviour of samples SP1-SP4 over time is shown in FIGS. 13 to 15. Coated sucrose behaved considerably different than pure sucrose (immediate sinking, FIG. 13). Increased fat content leads to increased quantity of floating powder. For samples SP1 and SP2 a part of powder sinks upon contact with water. Over time, rise of powder to the water surface can be observed. For samples SP3 and SP4 the entire amount of powder did float on the water surface. After manual mixing, rise of powder to the water surface could be observed for each sample.

### Example 9

Coating of Standard Sucrose with Sunflower Oil Using High-Shear Mixing

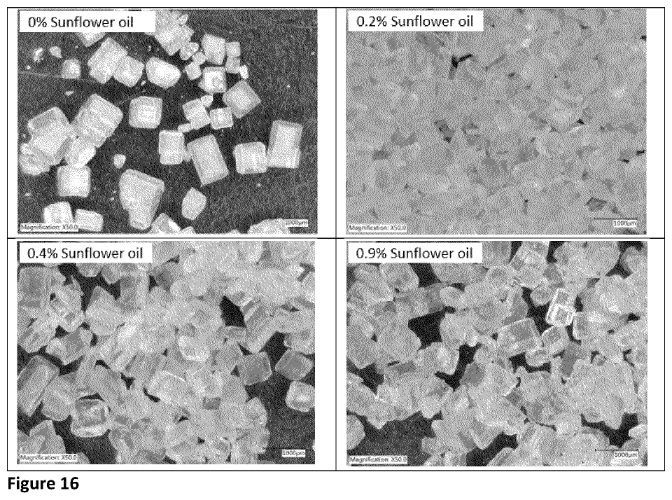

Standard sucrose (Schweizer Zucker AG, size class 500-710 μm) was coated with small quantities of sunflower oil using high-shear mixing. Composition of produced samples is given in Table 4. The oil content was determined by solvent extraction with n-Heptane at room temperature. Pure crystalline sucrose was used as a reference material. No difference in the appearance of each sample can be observed, as shown by microscopic images (FIG. 16).

TABLE 4
Composition of sample SSo1-SSo3 coated with
sunflower oil using high-shear mixing

| Sample | Sunflower oil [%] | Sucrose [%] |
|---|---|---|
| SSo1 | 0.9 | 99.1 |
| SSo2 | 0.4 | 99.6 |
| SSo3 | 0.2 | 99.8 |
| Reference | 0 | 100 |

### Example 10

Effect of Sunflower Oil Coating on Powder Floating

Powder floating/sinking was assessed using a standard wetting test. For the test, 15 g sample was added in a steel funnel (diameter 3 cm). This funnel was positioned on a metal plate on top of a beaker (diameter 7 cm, powder dropping height: 4.5 cm). The glass beaker contained 200 ml of water (23±1° C.). The plate was withdrawn by hand and floating/sinking behaviour of powder recorded.

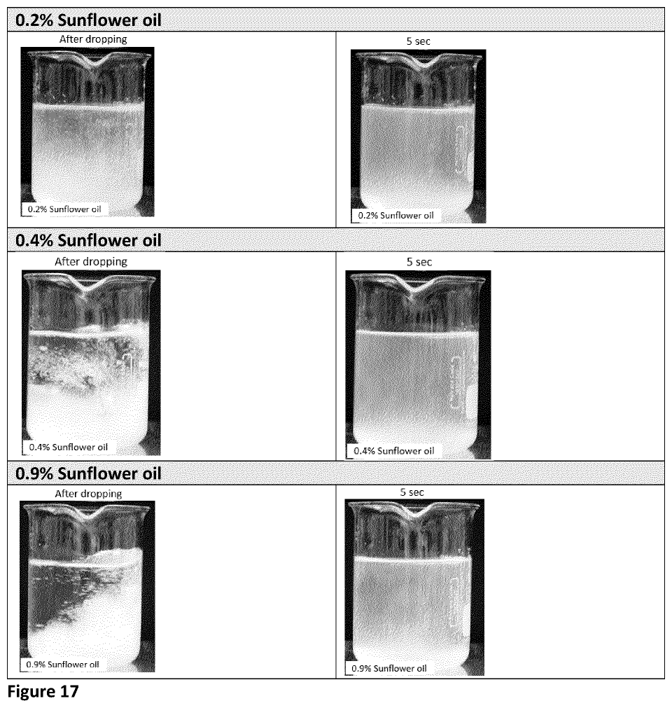

All sample immediately sunk upon contact with water, as shown in FIG. 17. Sunflower oil coating did not lead to powder floating.

### Example 11

Floating of Coated Powder in Milk, Coffee and Chocolate Milk

Powder floating/sinking was assessed for palm fat and cocoa butter coated powder in milk, coffee and chocolate milk. An overview of solid liquid combination is given in Table 5.

TABLE 5
Coated powder and used liquids to assess floating behaviour

| Sample | Liquid | |
|---|---|---|
| Standard sucrose coated | Milk | Semi-skimmed milk |
| with 1% palm fat using | | |
| high-shear mixer* | | |
| 1.2% cocoa butter, | Coffee | 3 g coffee powder (Classic |
| fluidized bed coated | | Russia RT 1000 standard |
| | | profil) dissolved in 200 ml |
| | | water |
| 1.2% cocoa butter, | Chocolate milk | 13.5 chocolate powder |
| fluidized bed coated | | (Nesquick, chocolate flavor) |
| | | dissolved in 200 ml semi- |
| | | skimmed milk |

*Palm fat was stained with 0.5% fat-soluble dye (E153) to enhance differentiation

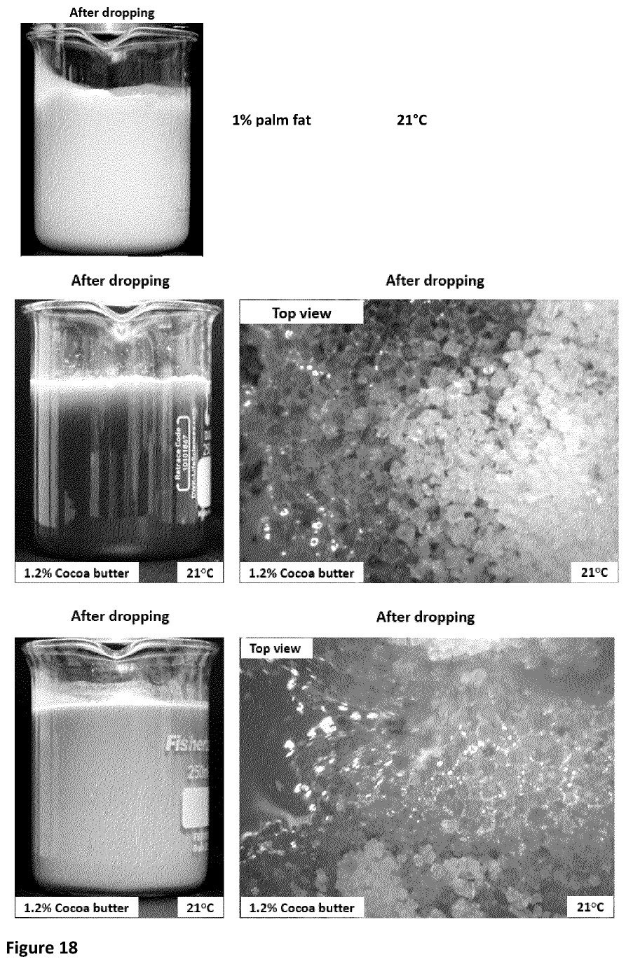

Floating was assessed using the standard wetting test, as shown in FIG. 18. For the test, 15 g sample was added in a steel funnel (diameter 3 cm). This funnel was positioned on a metal plate on top of a beaker (diameter 7 cm, powder dropping height: 4.5 cm). The glass beaker contained 200 ml of milk, coffee or chocolate milk, respectively (21±1° C.). The plate was withdrawn by hand and floating/sinking behaviour of powder recorded.

1. A beverage powder comprising crystalline tastant particles, the crystalline tastant particles are at least partially coated with a hydrophobic coating, and the at least partially coated crystalline tastant particles have an average density greater than 1 g/cm³.

2. The beverage powder according to claim 1, wherein the at least partially coated crystalline tastant particles have an average density greater than 1.5 g/cm³

3. The beverage powder according to claim 1, wherein the tastant particles are sucrose particles.

4. The beverage powder according to claim 1, wherein the tastant particles are, on average, between 1% to 50% coated with a hydrophobic coating.

5. The beverage powder according to claim 1, wherein the hydrophobic coating is solid fat or wax.

6. The beverage powder according to claim 5, wherein the melting temperature of the solid fat or wax is greater than about 35° C.

7. The beverage powder according to claim 5, wherein the solid fat is selected from cocoa butter or palm fat.

8. The beverage powder according to claim 1, wherein the coated tastant particles comprise, on average, about 1.2% cocoa butter.

9. The beverage powder according to claim 1, wherein the coated tastant particles comprise, on average, about 0.3% palm fat.

10. The beverage powder according to claim 1, wherein the coated tastant particles have a contact angle with water of, on average, greater than 70°.

11. The beverage powder according to claim 1, wherein the beverage powder is suitable for reconstitution in a liquid at a temperature of about 23° C.

12. A method for coating crystalline tastant particles with a hydrophobic coating, comprising the steps:
a. Fluidization of crystalline tastant particles;
b. Application of a hydrophobic coating; and
c. Fluidization to allow solidification of the hydrophobic coating.

13. A method for coating crystalline tastant particles, comprising the steps:
a. Mixing crystalline tastant particles with oil or molten fat or tempered fat;
b. Spreading out the mixture as a powder layer;
c. Storing the mixture;
d. Mixing; and
e. Spreading out the mixture as a layer and allowing it to solidify.

14. A method for coating crystalline particles according to claim 12, wherein the solid fat is cocoa butter at a final amount of about 1.2 wt %.

15. A method for coating crystalline particles according to claim 12, wherein the solid fat is palm fat at a final amount of about 0.2 to 0.3 wt %.

16-18. (canceled)
